(19) United States
(12) Patent Application Publication
(10) Pub. No.: US 2004/0167978 A1
(43) Pub. Date: Aug. 26, 2004

(54) Communication apparatus

(76) Inventor: Seiji Kitayama, Yokohama (JP)

Correspondence Address: SWIDLER BERLIN SHEREFF FRIEDMAN, LLP, 3000 K STREET, NW, BOX IP, WASHINGTON, DC, 20007, US

(21) Appl. No.: 10/727,558

(22) Filed: Dec. 5, 2003

(30) Foreign Application Priority Data
Dec. 24, 2002 (JP) 2002-372467

(51) Int. Cl. G06F 15/173

(52) U.S. Cl. 709/224; 709/225

(57) ABSTRACT

A communication apparatus and method which can quickly determine the link condition of the data link layer is provided. The communications apparatus comprises a receiving unit operable to receive link status flags, the link status flags included in frames received over a data communication link in response to link status flags included in frames transmitted over the data communication link, and a link status determination unit operable to determine whether a condition of the data communication link is normal based on whether the link status flags are received within a predetermined time.

### FIELD OF THE INVENTION

The present invention relates to a communication apparatus for monitoring and controlling the link status of a data link layer. More specifically, the present invention relates to a Synchronous Optical NETwork/Synchronous Digital Hierarchy (SONET/SDH) communication apparatus that transfers data through a link of a data link layer by encapsulating an IP packet or Ethernet frame into a frame that is similar to a frame [(“HDLC-Like frame”)].

### BACKGROUND OF THE INVENTION

With spread of the Internet, WAN'S, and LAN's, SONET/SDH communication apparatuses are increasingly being used as a medium for mutually connecting local networks formed from an Ethernet by accommodating the networks that are specified by IEEE 802.3 as the access link. The SONET/SDH communication apparatus also includes a transmission apparatus utilizing the SONET/SDH as the transit link interface and communication apparatus such as a router, switch, or the like.

The data link layer uses PPP (Point to Point Protocol), for transfer of IP (Internet Protocol) packets between the SONET/SDH communication apparatuses. PPP (Point to Point Protocol) as specified in protocols such as RFC1661/1662/2615, or the like, may be used. The PPP ensures point-to-point data transmission and also provides for additional functions, such as user authentication, or the like. Therefore, the PPP is suitable for the area service through the SONET/SDH communication apparatus. Additionally, protocols such as ITU-T X.86, and ITU-T G. 7041 GFP, for mapping the Ethernet frame to the payload of SONET/SDH frame (SONET/SDH Payload) may be used.

In order to ensure the quality of services provided, it is preferable to monitor the link condition of the data link layer among the SONET/SDH communication apparatuses.

End users, such as companies, generally utilize the SONET/SDH network provided by communication companies in order to provide access to the Internet and Intranet in remote areas via a private line or the Ethernet. This is typically because the quality of services provided through the SONET/SDH network is high.

For data transfer among the SONET/SDH communication apparatuses, the PPP is used as the protocol of the data link layer (PPP over SONET/SDH: referred to as “POS”). FIG. 10 is a diagram illustrating an example of the mutual connection of LANs among the SONET/SDH communication apparatuses using the PPP.

In FIG. 10, each communication apparatus (communication apparatus 1 and 2) transfers the SONET/SDH signal by mounting the Ethernet to the access line, encapsulating the Ethernet signal into the PPP and then mapping such capsules to the payload of SONET/SDH.

Each communication apparatus typically includes a MAC unit for sending the MAC frame, such as using 100BASE-TX and Gigabit Ethernet, or the like. Also included is a PPP unit for mapping the MAC fame to the POS frame, and an STS unit for mapping the POS frame to the SONET/SDH Payload. The part for cross-connection of the SONET/SDH Payload and the part for converting the SONET/SDH Payload into the standard format OC-48 are optionally included.

The Ethernet signal terminated to the MAC unit is then mapped to an HDLC-Like frame at the PPP unit. The frame format described in the first line (upper most stage) of FIG. 11 illustrates a format of the HDLC-Like frame.

The Ethernet signal (user data) terminated at the MAC unit is inserted to the “information” field of the HDLC-Like frame. The contents of the information field are identified based on a value set to the “protocol” field. For example, if the upper layer of user data inserted into the information field is IP, the value of the protocol field is set to “0×0021”.

The PPP is the protocol of the data link layer. Therefore, the procedure to establish a link must be executed between the PPP termination areas (PPP units of the communication apparatuses 1 and 2 illustrated in FIG. 10). After establishment of the link, data (user data) can be transmitted among the communication apparatuses. At the PPP, the link establishment procedure is specified with the LCP. (Link Control Protocol). In FIG. 11, the LCP frame in the POS is defined.

Like the user data, the LCP frame has the HDLC-Like frame format illustrated in the first line (upper most stage) of FIG. 11. However, as illustrated in the second line (second stage from the upper side) of FIG. 11, the LCP frame has the protocol field, information field and padding field like the HDLC-Like frame for the user data. The data related to the LCP is inserted into the information field, while a value indicating LCP (LCP=0×C021) is set to the protocol field. The padding field is a pad to keep the data length of the information field larger than a specified value.

In the third and fourth lines (third and fourth stages from the upper side) of FIG. 11, a format in the information field of the LCP frame is defined. The “Code” field is provided to set a value for identifying various requests and responses for the LCP link control. Values of the “Identifier”, “Length”, and “Data/Option” fields following the “Code” field depend on the kind of the LCP link control request and response.

FIG. 12 is a sequence diagram illustrating the LCP link control procedure among the communication apparatuses illustrated in FIG. 10. When the LCP link is established, as illustrated in FIG. 12, with the link establishment request from the upper layer or the external factor such as power ON and reset of the apparatus, the procedures for transmitting and receiving the “LCP link setting request frame” and the “LCP link setting verification frame” for the LCP link setting request frame are performed between the PPP units of the communication apparatuses 1 and 2. When the LCP link setting verification frames of both apparatuses are received, the link is established (LCP link Opened).

Thereafter, the authentication procedure provided as an option in the LCP is driven as required. Thereafter, when the link is disconnected due to a link disconnection request from the higher layer and the external factor, the procedure to transmit and receive the “LCP link end request frame” and “LCP link end verification frame” is performed between the PPPs of the communication apparatuses 1 and 2 (LCP link closed).

As described above, the PPP establishes the link among the apparatuses (PPPs). Therefore, it may be necessary to account for the link being disconnected due to the absence of a signal (disconnection of optical fiber) among the communication apparatuses. After the link is disconnected, transfer of user data cannot be ensured and therefore the procedure to establish the link again (re-establishment of link) must be performed.

In the PPP, the monitoring procedure for monitoring the link condition in the physical layer (using Carrier Detection signal) is specified. This assumes the use of a modem with an analog (telephone) line that monitors the link condition of the LCP message. The previously discussed monitoring of the physical layer cannot be applied to the POS. In the monitoring POS, as illustrated in FIG. 12, the side for inspecting the link condition (inspecting side: for example, the communication apparatus 1 in FIG. 10) transmits a “LCP ECHO request frame” under the LCP link opening condition. The side for receiving the LCP ECHO request frame (responding side: for example, the communication apparatus 2 in FIG. 10) returns, upon reception of the LCP ECHO request frame, a “LCP ECHO response frame”. The inspecting side determines that it has received the “LCP ECHO response frame” from the response side before a constant time (time defined with a response waiting timer) passes, and that the link condition is normal. It may also determine, when it cannot receive the frame, that the link condition is not normal.

The procedure for monitoring link conditions such as the enabling function, disabling function, a value of the response waiting timer, and protection during detection of disconnected condition may be varied as desired. Usually, the link monitoring function is invalidated or protection is provided for detection of the disconnected condition (retry is repeated several times after the constant period) even when the link monitoring function is validated.

As described above, in the POS, the link monitoring method in the physical layer, namely the determination procedure and condition for link disconnection and recovery thereof are not specified. Therefore, the link monitoring of data link layer by the LCP message is unnecessarily substituted for the link monitoring in the physical layer. Here, the link monitoring by the LCP message has the following problems:

First there is a risk of erroneously recognizing the link condition due to data traffic load. Frequently, user data exceeds the permitted bandwidth. If the other communication apparatus (responding side) has a delay in responding with the LCP ECHO response frame due to user data traffic load when one communication apparatus (inspecting side) transmits the LCP ECHO request frame, the response waiting timer will probably generate a time-out condition. In this case, the link condition is actually normal but the response from the responding side is temporarily delayed due to the load. However, the inspecting side will erroneously recognize disconnection of link.

When the protection function (disconnected condition is determined by implementing the retry several times after the constant period and continuously detecting the disconnection of the link the designated number of times) is applied for determination of disconnected condition in the inspecting side to prevent the problem described above, the time required by the inspecting side to determine the condition that “link is disconnected” becomes longer when disconnection of link is actually generated. Therefore, the period of trouble with the service (the period up to the recovery from disconnection of link) will probably be extended.

When the link monitoring function by the LCP message is not installed or it is invalid, even when it is installed, determination of link OFF (disconnection) is not implemented.

There is also a problem particular to the SONET/SDH communication apparatus. The SONET/SDH communication apparatus has a cross-connecting function. Change of setting for the cross-connection typically causes adverse effects on the PPP link. Therefore, the cross-connecting condition must be defined as a condition to determine the link condition, in addition to application of the condition of the external line (optical signal, in this case) to determination of link condition. Monitoring of the external line and cross-connecting condition is usually performed using hardware or firmware. When determining the link condition based on such direct parameters, the process is very complicated when there are many parameters that are monitored. Moreover, when parameters that are monitored are added, hardware or firmware must be changed. If link condition can be determined with the common indirect parameters that are generated by such direct parameters, in place of the direct phenomena, complicated changing of hardware or firmware will no longer be required in the future.

When the PPP link is disconnected, the Ethernet frame received from the access line (Ethernet) side will be wasted with the SONET/SDH communication apparatus. In this case, disposal of the Ethernet frame is not conveyed to the apparatus (for example, an ordinary LAN switch and a terminal) which has transmitted the Ethernet frame. This is typically because the PPP unit for monitoring the link condition and the MAC unit for terminating the Ethernet frame are independent of each other. The technology to indicate the link condition to the MAC unit from the PPP unit has not yet been proposed, and it is not standard to implement the flow control (instructing temporary stop of frame transmission and restart of transmission to the Ethernet side) by indicating the link condition. Disposal of the frame described above is cancelled when the disconnecting condition of the PPP link is recovered and the link is re-established. However, recovery of the link condition is not conveyed to the MAC unit from the PPP unit. Therefore, protection by retransmission of the user data transmitted during the period where the link is disconnected cannot be applied to the transmission side of Ethernet frame (LAN switch or terminal side).

Under the operation mode (network structure of the Server-Client type) where a plurality of other apparatuses are connected in a star configuration to only one SONET/SDH communication apparatus, the LCP ECHO request frame is sometimes periodically transmitted from the Server side apparatus in order to monitor the link condition. In this case, when the number of the Client side apparatuses to be connected increases, the processes required for monitoring of a link are also increased as well, resulting in a lowered probability of processing the user data. This operation mode is generally applied in the case where the head office and branches are connected and communications among the branches are not required, and in the case where connection to the Internet or to a branch is allowed only via the head office, in order to maintain security.

### SUMMARY OF THE INVENTION

The present invention has been proposed considering the problems described above. The present invention preferably provides a communication apparatus which enables quick determination of the link condition.

The present invention also preferably provides a communication apparatus which can improve reliability in determination of the link condition.

The present invention further preferably provides a communication apparatus which can realize flow control based on the link condition.

In one embodiment of the present invention, a communications apparatus comprises a receiving unit operable to receive link status flags, the link status flags included in frames received over a data communication link in response to link status flags included in frames transmitted over the data communication link, and a link status determination unit operable to determine whether a condition of the data communication link is normal based on whether the link status flags are received within a predetermined time.

In one aspect of the present invention, the link status determination unit is further operable to determine that the condition of the data communication link is invalid when the link status flags are not received within the predetermined time.

In one aspect of the present invention, the link control unit is further operable to close the data communication link when the data communication link is determined to be invalid. The link control unit may be further operable to open the data communication link when the recovery of the data communication link is determined to be possible.

In one aspect of the present invention, the communications apparatus further comprises a negotiation unit operable negotiate validity or invalidity of the data communication link with a link status determination unit of another device connected to the data communication link. The negotiation unit may be further operable to transmit information requesting validity or invalidity of the data communication link to the link status determination unit of the other device connected to the data communication link and to receive a response from the link status determination unit of the other device connected to the data communication link.

In one aspect of the present invention, the communications apparatus further comprises a setting unit operable to set the link status determination unit to a valid or invalid condition. The negotiation unit may be further operable to transmit information indicating a valid condition of the link status determination unit to the other device connected to the data communication link and the setting unit is further operable to set the link status determination unit to an invalid condition when the negotiation unit receives response indicating invalidity of the link status determination unit of the other device connected to the data communication link.

In one aspect of the present invention, the communications apparatus further comprises a link monitoring unit which is operable when the link status determination unit is set to an invalid condition and is operable to transmit an inspection frame to inspect a condition of the data communication link to the other device connected to the data communication line and to determine that a condition of the data communication link is normal upon receiving a response frame for the inspection frame from the other device connected to the data communication line within the predetermined time.

In one aspect of the present invention, the communications apparatus further comprises a transmitter operable to transmit transmission object data received from a data transmission source over the data communication link, and a data transmission control unit operable to suspend data transmission to the data transmission source when the data communication link is closed. The data transmission control unit may be further operable to re-start data transmission to the data transmission source when the data communication link is re-opened.

In one aspect of the present invention, the communications apparatus further comprises a transmitter operable to transmit transmission object data received from a data transmission source over a data link layer of the data communication link, and a data transmission control unit operable to suspend data transmission to the data transmission source when the data communication link is closed. The data transmission control unit may be further operable to re-start data transmission to the data transmission source when the data communication link is re-opened.

### BRIEF DESCRIPTION OF THE DRAWINGS

FIG. 1(A) illustrates an example of a format of the PPP over SONET/SDH (POS) frame.

FIG. 1(B) illustrates an example of a flag.

FIG. 1(C) illustrates an example of the condition where the PPP packets are exchanged.

FIG. 1(D) illustrates an example of the idle condition.

FIG. 2 is an example of a structure of the communication apparatus of the present invention.

FIG. 3 is an example of a procedure for the link OFF determination process by the POS control portion.

FIG. 4 is an example of a transition of a condition of the link control portion.

FIG. 5 is an example of a format used when validity/invalidity of the flag monitoring function is defined to the LCP.

FIG. 6 is an example of a sequence diagram of the case where the setting of validity of the flag monitoring function is accepted in the negotiation.

FIG. 7 is an example of a sequence diagram of the case where the setting of validity of the flag monitoring function is rejected in the negotiation.

FIG. 8 is an example of a format of the Pause frame.

FIG. 9 is an example of a structure of the communication apparatus as an embodiment of the present invention.

FIG. 10 is an example of a structure of the prior art.

FIG. 11 is an example of a format of the prior art.

FIG. 12 is an example of the prior art

### DESCRIPTION OF THE REFERENCE NUMERALS

A, A2, X, Y: Communication apparatus (SONET/SDH Communication Apparatus)

45: PPP unit (setting means, negotiation means, link monitoring means)

50: POS control portion (receiving means, determination means)

51: Link OFF monitoring timer (timer)

60: Link control portion (data transmission control means)

61: MAC control portion

### DETAILED DESCRIPTION OF THE PREFERRED EMBODIMENT

The preferred embodiments of the present invention will be described with reference to the accompanying drawings. Structures of the embodiments are only examples and the present invention is not limited the structures of the embodiments.

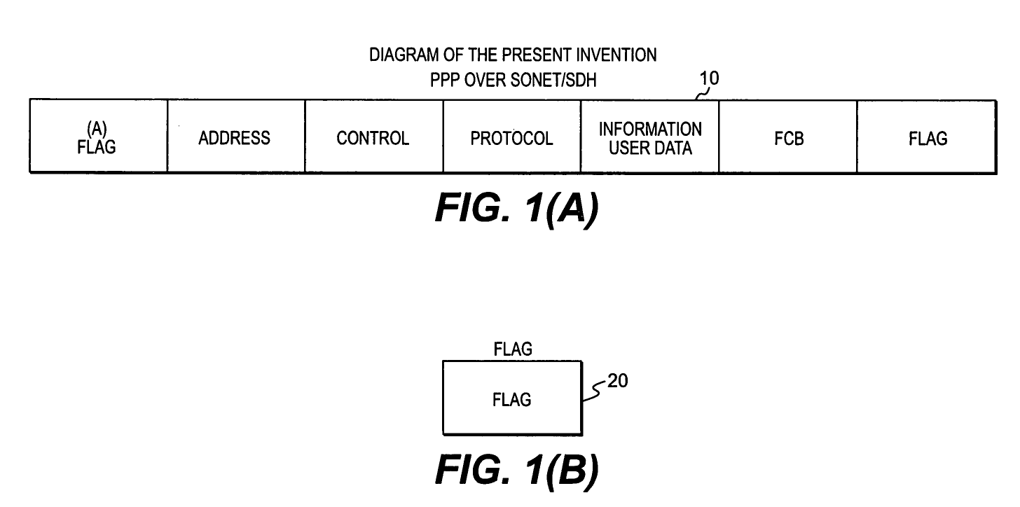

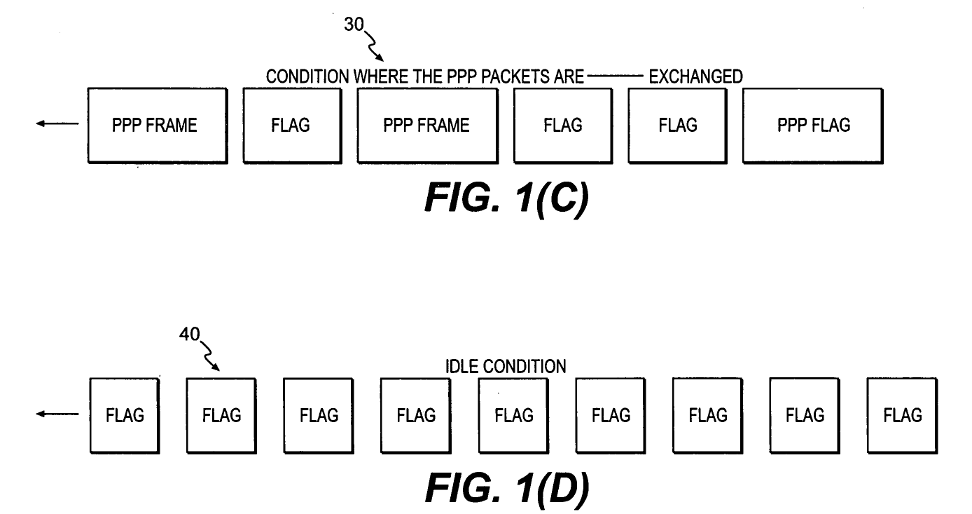

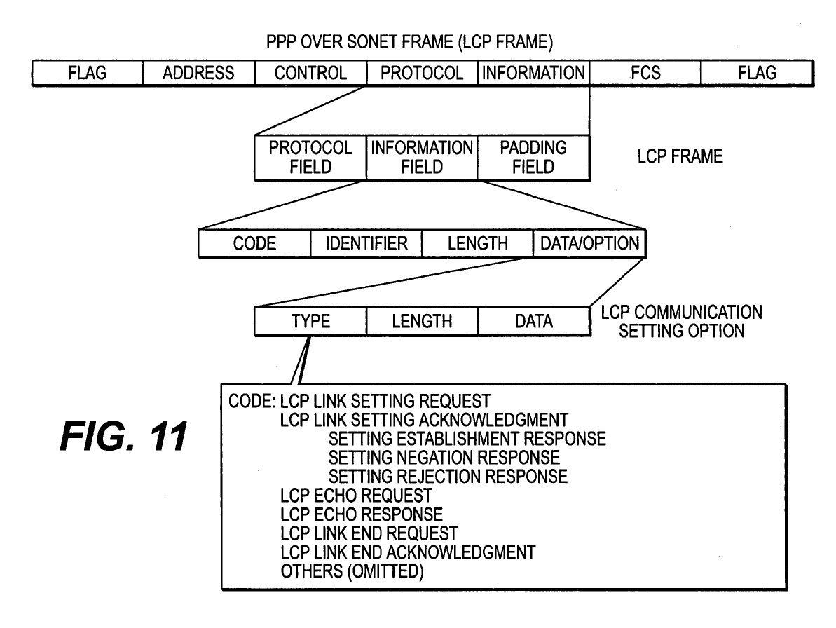

FIG. 1(A) illustrates a format of the PPP over SONET/SDH (POS) frame. In one embodiment, the POS frame illustrated in FIG. 1(A) is transmitted over the link of a data link layer (for example, PPP link) established between the data transmitting side and receiving side. Any link, such as a PPP link, or the like, may be used. The POS frame 10 is only one of the PPP frame and has the HDLC-Like frame format as illustrated in FIG. 11.

When the user data is transmitted using the POS frame 10, the user data is inserted to the “information” field of the POS frame 10. However, the present invention does not depend on the content of the information field.

In one embodiment, the user data is transmitted only when a transmission request is sent from the own apparatus or from an opposite apparatus and does not always flow on the link. When the user data and the other control data do not flow (idle condition), a protocol such as RFC1662, or the like, allows flag 20 (FIG. 1(B)) (having the value of “0×E” or “01111110b” like the flag of HDLC) to flow.

Namely, the flag is preferably transmitted when there is no data (transmission object data), from the transmitting side to the opposite apparatus (receiving side) when there is no data. Accordingly, when the transmission object data is transmitted or received between the transmitting side and the receiving side, the PPP packets 30 in FIG. 1(C) are exchanged on the link. The flags and the PPP frame (POS frame), including the transmission object data are transmitted in serial. When there is no transmission object data in the transmitting side, the idle condition 40 in FIG. 1(D) appears on the link (only flags are transmitted in serial). When the established link is normal as described above, the flags sequentially arrive at the receiving side in the predetermined interval through the link.

At substantially the same time, the receiving side is assumed, under the condition that the link condition is normal and the link is established, to receive the flags (in the predetermined interval) even when the user data and control data are not received from the opposite apparatus. When a failure occurs in the link condition, the receiving side cannot receive the flags. Therefore, the normal/fault condition of a link can be detected by monitoring the receiving condition of flags in the receiving side.

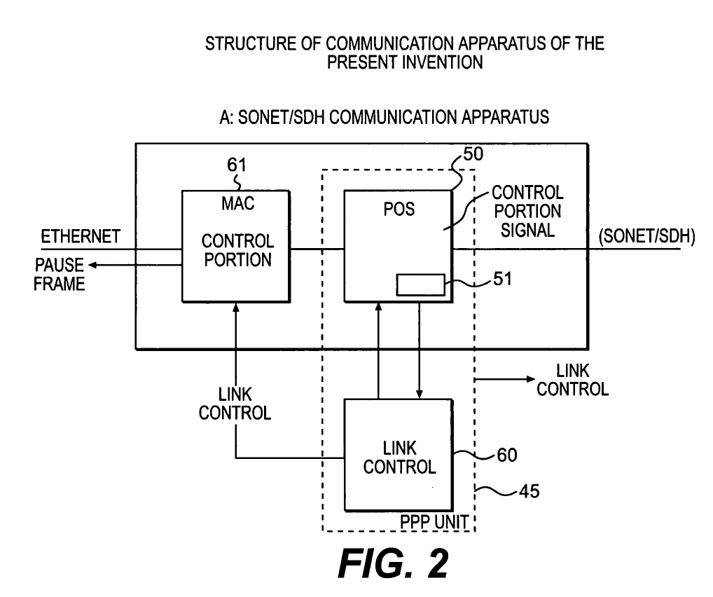

FIG. 2 illustrates a structure of the communication apparatus of the present invention. In FIG. 2, a structure of the PPP unit 45 mounted to the SONET/SDH communication apparatus A is illustrated. The PPP unit 45 preferably comprises the setting means, negotiation means, link monitoring means, and link monitoring apparatus. The unit 45 is provided with a PPP over SONET/SDH(POS) control portion 50 (corresponding to the receiving means, determination means) and a link control portion 60 (corresponding to the link control means, data transmission control means).

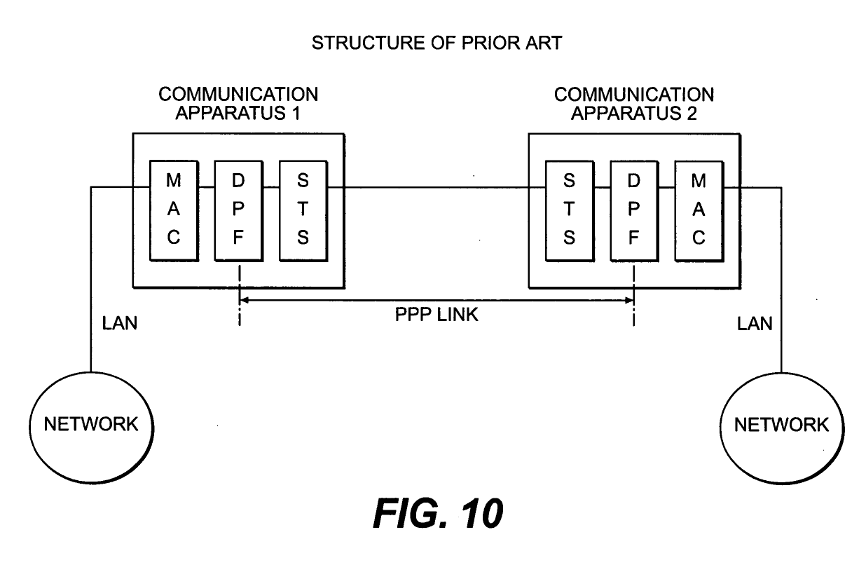

In one embodiment the POS control portion 50 monitors the flag receiving condition of the POS frame in addition to conventional functions. Conventional functions may include mapping the MAC frame terminated by the MAC control portion 61 (corresponding to the MAC unit of FIG. 10) to the POS frame. The POS frame terminated with the STS unit (refer to FIG. 10) is then received. The POS frame is the mapped to the MAC frame. Namely, the POS control portion 50 is configured to receive the flags which sequentially arrive within a certain interval through the link.

The link control portion 60 monitors the flag receiving condition information of the POS frame that is notified from the POS control portion 50. Additionally, the link control portion 60 monitors conventional phenomena, such as the request from the higher layer and the other external factors, and performs the link condition control based on such information for the POS control portion 50.

After the PPP link establishment procedure is executed for the PPP unit 45 of the SONET/SDH communication apparatus, the POS control portion 50 determines reception or non-reception of the flags from the opposite apparatus. This preferably occurs when the PPP link is established (LCP link•Opened).

In one embodiment, the POS control portion 50 includes a link OFF monitoring timer for clocking the predetermined time (monitoring timer) 51. The timer also drives the monitoring timer 51 for every reception of the flag. The value of the monitoring timer 51 (predetermined time clocked by the monitoring timer 51) is the (bits) time necessary to assure that the disconnecting condition of the link is never detected under the ordinary condition.

In one embodiment, the maximum length of a frame in the POS is about 1500 bytes. When the frame has the maximum length, the period up to the next flag (inserted at the end of data or between two continuous frames) from a flag (start of data) becomes 1,531 bytes. (1,531×8=12,248 bits time) Therefore, the predetermined period is set not to determine disconnection of a link until at least the above stated period has passed (the timer does not generate time-out). However, when the value of monitoring timer 51 (predetermined time) is set to a substantially longer value, the actual determination for disconnection of link is delayed. As described above, the predetermined time set for the monitoring timer 51 can be set longer than the maximum value of the interval, even if the flag arrives under the normal condition of link.

The POS control portion 50 preferably controls the monitoring timer 51 to generate the time-out condition when the flags are not received during the predetermined period. It also sends the time-out condition of the monitoring timer 51 to the link control portion 60 (refer to the arrow mark written as the “link condition” in FIG. 2).

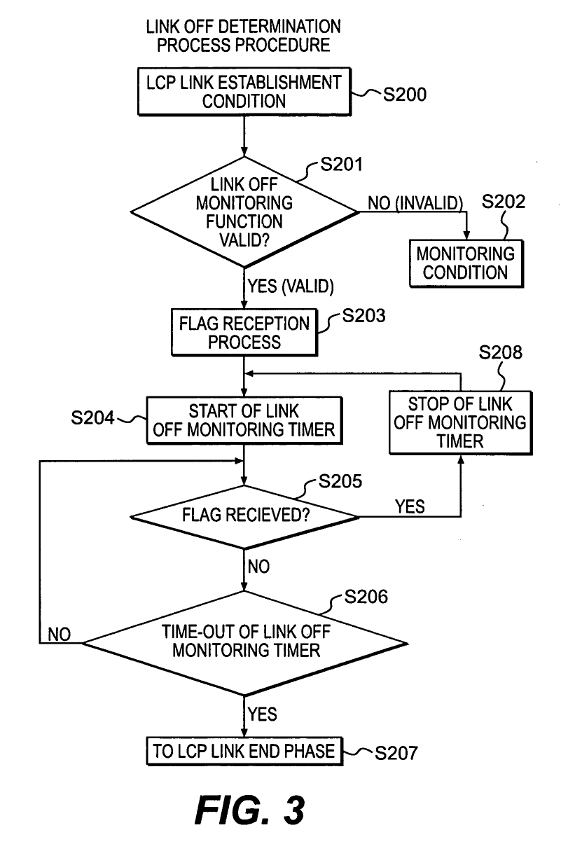

FIG. 3 illustrates a link OFF determination processing procedure by the POS control portion. In FIG. 3, it is determined in step S201 whether the flag monitoring function is valid or invalid under the LCP link open condition (LCP link is established) (step S200). When this function is valid (S201: YES), the flags are monitored with the POS control portion 50. When this function is invalid (S201: NO), the flags are not monitored. This is shown in step S202, and will be described in more detail below.

When the flags are monitored (the flag monitoring function is valid), the POS control portion 50 waits for reception of a flag in step S203. It starts the clocking after verification of reception of the flag. This is done by the monitoring timer 51 in the step S204. This repeats the loop process which includes determining the reception of the next flag (step S205). The step also includes determining whether the time out the monitoring timer 51 (step S206) should occur when the next flag is received (S205: YES).

Upon detection (S206: YES) of a time-out (clocking of the predetermined time) of the monitoring timer 51 in the step S206, the POS control portion 50 notifies the link condition (link failure: determination for disconnection of link) to the link control portion 60. The POS control position 50 then instructs the link control portion 60 to close the LCP link (shifting to the link end phase: step S207).

Meanwhile, the POS control portion 50 stops when the next flag is received in the step S205. Before the monitoring timer 51 generates the time-out condition, the monitoring timer 51 (step S208) restarts (reset) the monitoring timer 51 to monitor the reception of the next flag (step S204).

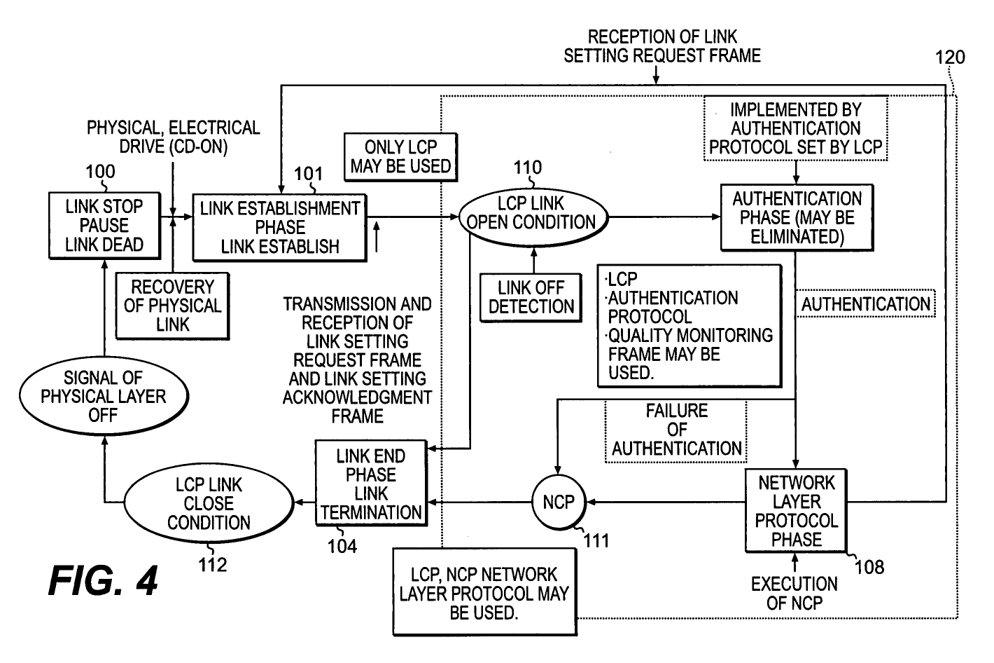

In one embodiment the link control portion 60 is a state machine. FIG. 4 is an exemplary state transition diagram of the link control portion 60. In the state transition diagram of FIG. 4, the flag reception monitoring condition of the present invention is preferably added to the state transition (refer to “RFC1661 (Point-to-Point Protocol) 3.2 Phase Diagram) of the link control specified by the PPP.

FIG. 4 illustrates an exemplary a state transition under the management of the link control portion 60. In the FIG. 4 embodiment, 100 is a link stop phase where the link does not operate physically and electrically. When the link is operated physically or electrically, the link enters the link establishment phase 101. In this embodiment, the LCP link setting request•verification frames are exchanged with each other for establishment of link.

In such an embodiment, when exchange of the LCP link setting request and verification frame is completed normally, the link enters the LCP link open condition. Thereafter, the authentication protocol 102 is executed, when it is necessary, before the network layer protocol phase 103. In some embodiments execution of the authentication protocol may be eliminated or modified.

In the network layer protocol phase 103, NCP (Network Control Program) corresponding to the network layer protocol to be mounted is preferably respectively executed. Accordingly, the NCP link•open condition 111 starts.

Thereafter, when the LCP link is closed, the condition is shifted to the link end phase 104 to close the LCP link. Thereby, the condition enters the LCP link•close condition 112.

The link control portion 60 preferably monitors the link based on the link condition information sent from the POS control portion 50 under the LCP link•open condition 110. When disconnection of the LCP link (LCP link OFF) is detected from the link condition information, the condition is shifted to the link end phase 104. As described above, disconnection (detected) of the LCP link is a trigger for transition to the link end phase 104 from the LCP link open condition 110.

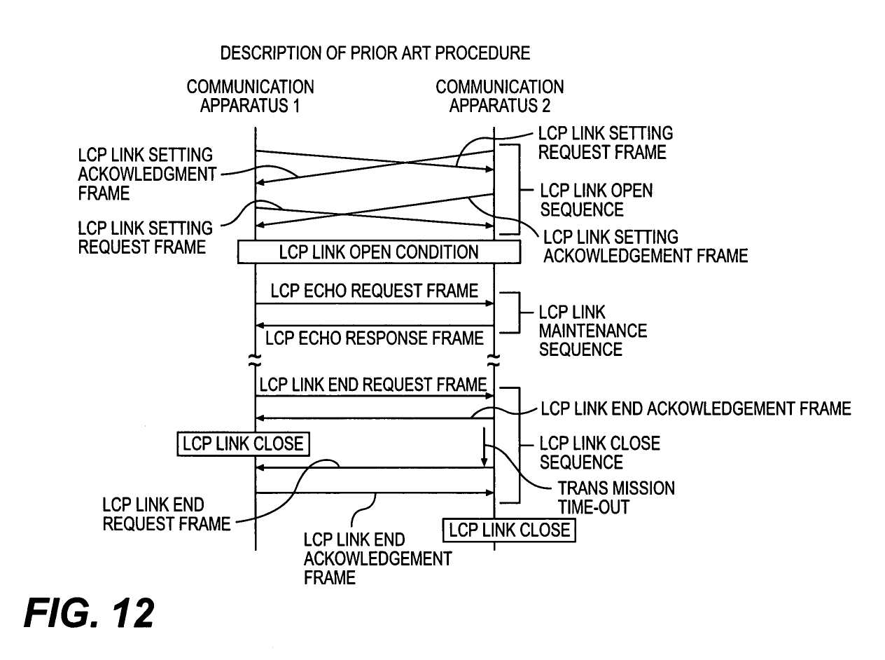

In one embodiment, when the link control portion 60 shifts to the link end phase 104, the LCP link close sequence (FIG. 12) is implemented between its own apparatus and an opposite apparatus. The apparatus 60 then shifts to the LCP link close condition 112.

Disconnection of the link is generated when the physical link (optical fiber) for establishment of the data link is disconnected. Such failure is recovered through exchange of optical fiber. Recovery of the physical link (optical fiber) may be detected through transmission and reception of one or more signals in the physical layer. When physical link recovering is detected in the physical layer, the link control portion 60 shifts to the link establishment phase 101 to re-establish the link of the data link layer.

Here, it is also assumed that the structure of one embodiment the present invention (flag monitoring function by the POS control portion 50) is applied to the opposite communication apparatus, while the other opposite apparatus is in the idle condition and does not transmit the flag. In this case, when the communication apparatus is on the receiving side, it always detect a disconnection of the link. In this case, the exemplary communication apparatus of the present invention may have a valid/invalid setting function, set valid, or the invalid link monitoring function described above.

FIG. 3 illustrates, in steps S2201 and S202, the processes to be executed when the valid/invalid setting function is added. As described above, when the monitoring function is set to “valid”, the determination result is “YES” (valid). In step S201, the flag monitoring function described above is preferably operational (S203 to S207). On the other hand, when the flag monitoring function is set to “invalid”, the determination result in step S201 is “NO” (invalid). In this case, the monitoring function does not operate (S202) and disconnection of the link is not detected even when the flag is not received.

However, the PPP unit 45 of the communication apparatus is preferably provided with the link condition monitoring function (refer to FIG. 12) by the LCP ECHO request frame. When the flag monitoring function is “invalid”, this link condition monitoring function may be operated. Accordingly, it is possible to ensure the mutual connection with the link (PPP link) of the data link layer for the communication apparatus to which the link condition monitoring function of the present invention is not applied.

In some embodiments, the monitoring function valid/invalid setting described above may be implemented using the user interface. In one embodiment, the setting must be executed for every opposite communication apparatus. In this case, implementation of the monitoring function valid/invalid setting to every communication apparatus may be burdensome. In addition, a certain contradiction that the one opposite communication apparatus is set to the valid condition while the other apparatus is set to the invalid condition may result.

Therefore, it is also possible, by utilizing the negotiation function provided by the LCP, to introduce a method where the setting in one of the communication apparatuses is automatically reflected on the opposite communication apparatus.

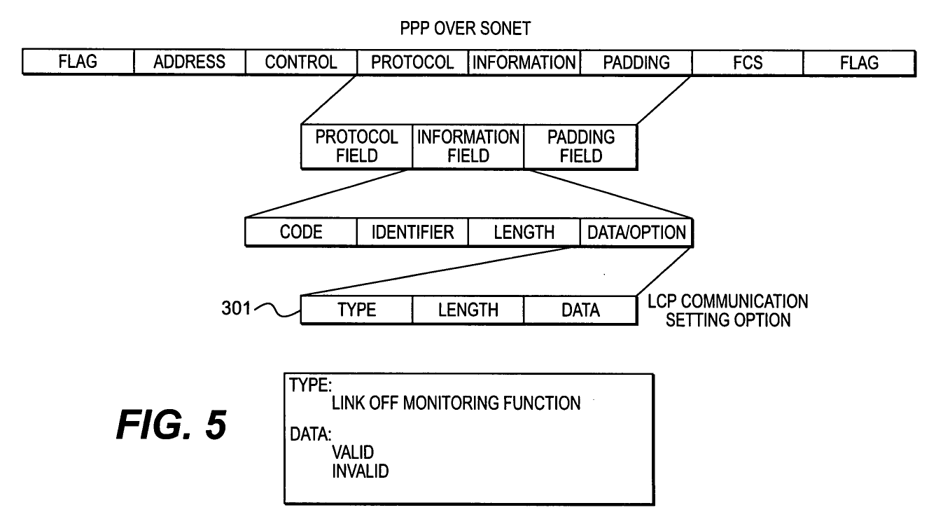

FIG. 5 illustrates an exemplary format (a format of the LCP frame where the valid/invalid setting of the monitoring function is defined) when setting of the valid/invalid of the monitoring function is defined for the LCP.

In the FIG. 5 embodiment, the value of the protocol field is “LCP(0×C021:existing)” and the value of “Code” of the information field is set to “Configure-Request (existing)”. Moreover, for the Data/Option field, the setting for the monitoring of the link OFF condition, “Type=0×0A (0Ah): link OFF monitoring function”, “Data=0×0000(0000h:valid)/0×001(0001h:invalid” is newly set. The Data/Option field that includes the definition of setting of monitoring is called the communication setting option 301.

In the LCP link establishment phase 101 of FIG. 4, the negotiation using the Link Configuration frame (Configure-Request, Configure-Ack, Configure-Nak, Configure-Request) for the LCP link establishment and setting of LCP communication is preferably implemented between the communication apparatuses. The Configure-Request frame is used for the LCP communication setting request. The communication setting is preferably negotiated between the apparatuses. For the Data/Option field of the Configure-Request frame, the communication setting option 301 illustrated in FIG. 5 is preferably defined.

The default setting of the link OFF monitoring function is “invalid”. In the LCP establishment phase 101, negotiation is performed by designating “valid” to the communication setting option 301 by first setting one of the communication apparatuses to the negotiation side. When the designation of “valid” is accepted by setting the other communication apparatus as the communication partner, one communication apparatus performs the link OFF monitoring operation based on the setting of “valid”, after the LCP link is established. On the other hand, when the communication partner rejects designation of “valid”, the monitoring function is set to “invalid” and the link OFF monitoring operation is not performed even after the LCP link is established.

In the exemplary structure (negotiation function) described above, the procedure to set for every communication apparatus whether a user can set link OFF monitoring to valid or invalid may be eliminated. Contradiction of setting among the opposite apparatuses may also be eliminated. The negotiation function is specified in the “RFC1661(Point-to-Point Protocol) 4. The Option Negotiation Automation”.

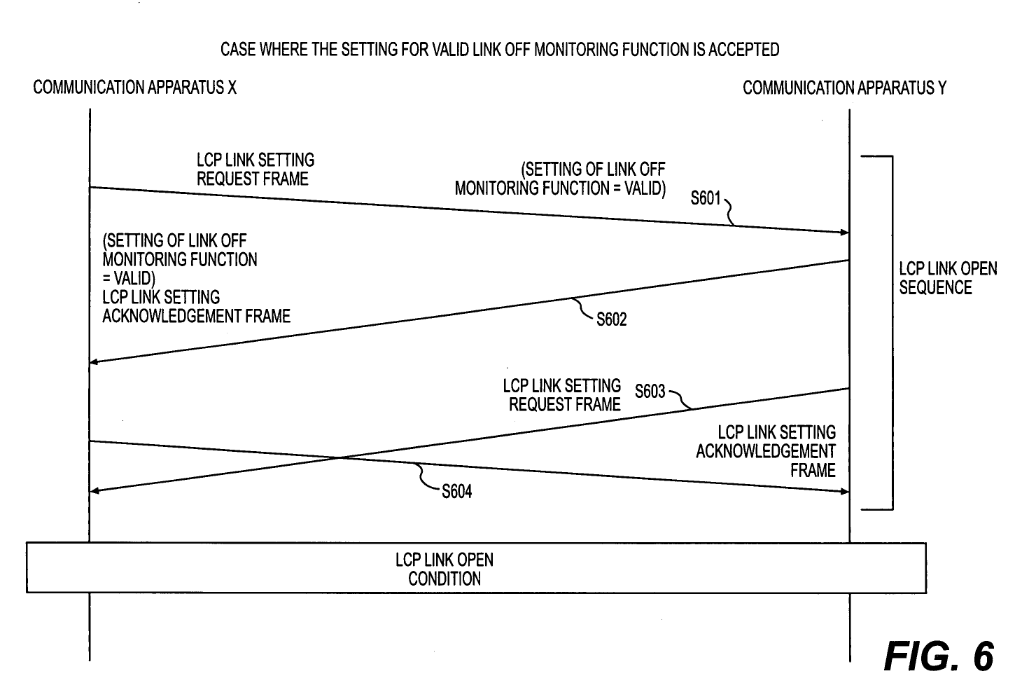

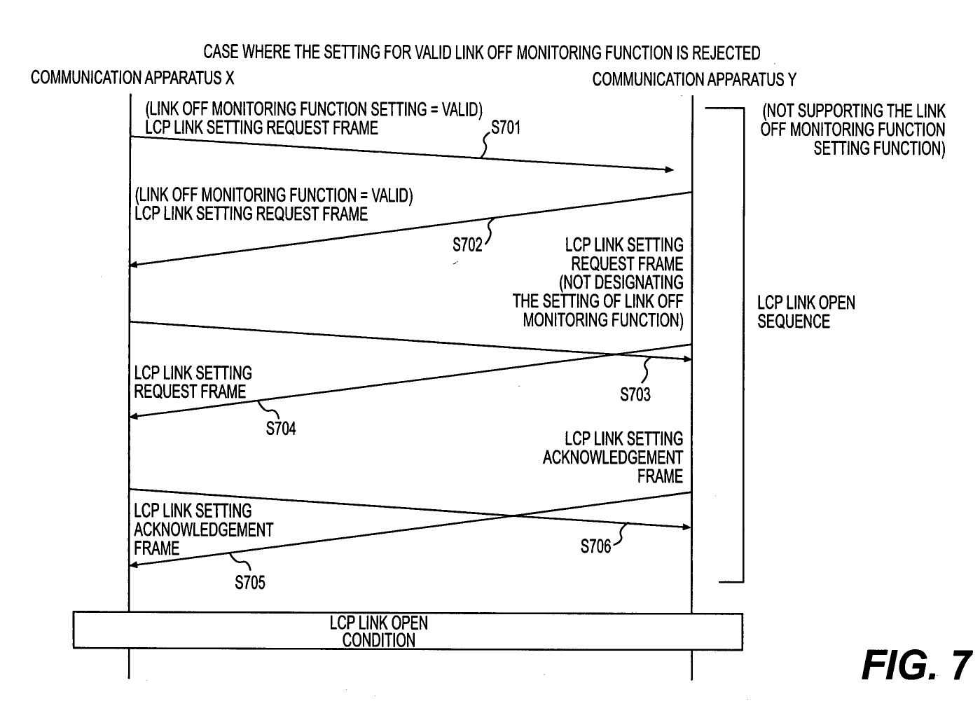

FIG. 6 is an exemplary sequence diagram illustrating an embodiment where the monitoring function valid setting is accepted in the negotiation. FIG. 7 is an exemplary sequence diagram illustrating the case where the monitoring function valid setting is rejected in the negotiation.

In FIG. 6, when the communication apparatus X and communication apparatus Y (these apparatuses respectively have the flag monitoring function and the function to recognize the communication setting option 301) establish the PPP link. One communication apparatus (communication apparatus X in FIG. 6) transmits first, in the LCP link open sequence (link open phase), the LCP link setting request frame, where “valid” is set, (the Configure-Request frame including the communication setting option 30 where “valid” is set) to the opposite side (communication apparatus Y) (step S601).

In this case, when the opposite side (communication apparatus Y) accepts “valid” and it also completely accepts the other communication setting options in the Configure-Request frame, the communication apparatus Y transmits the Configure-Ack (communication setting acknowledgment response) frame (step S602).

Moreover, the communication apparatus Y transmits, to the communication apparatus X, the Configure-Request frame including the communication setting option 301 where “valid” is set (step S603). On the other hand, the communication apparatus X transmits the Configure-Ack frame to the communication apparatus Y when it has accepted all communication setting options including the setting of “valid” in the Configure-Request frame (step S604).

As described above, the communication apparatuses X and Y preferably establish the LCP link by receiving the Configure-Ack frame from the opposite side and set the flag monitoring function to the valid condition. Accordingly, the communication apparatuses X and Y respectively implement the flag monitoring operation respectively.

In FIG. 7, when the communication apparatus X, (having the flag monitoring function and the function to recognize the communication setting option 301) and the communication apparatus Y, (having the flag monitoring function and the function to recognize the communication setting option 301) are positioned opposite with each other. They preferably establish the PPP link. One communication apparatus (communication apparatus X in FIG. 7) transmits first, in the LCP link open sequence (link open phase). In exemplary step S601, the LCP link setting request frame (Configure-Request frame including the communication setting option 301 where “valid” is set) is sent to the opposite communication apparatus (communication apparatus Y) (step S701).

In this case, the communication apparatus Y rejects the LCP link setting request because it cannot recognize the setting of “valid” of the communication option 301. The communication apparatus Y transmits, in order to reject the LCP link setting request, the LCP link setting rejection frame (Configure-Reject(rejection of communication setting) frame) to the communication apparatus X (step S702).

The communication apparatus X transmits, upon reception of the Configure-Reject frame, the Configure-Request frame not including the communication setting option 301 where the monitoring function setting is designated to the communication apparatus Y (negotiation is retried without communication option 301: step S703).

On the other hand, the communication apparatus Y transmits, to the communication apparatus X, the Configure-Request frame not including the communication setting option as the negotiation object (not including the communication setting option 301) (step S704).

The communication apparatus Y transmits, to accept the communication setting option in the Configure-Request frame, the Configure-Ack frame (step S705).

The communication apparatus X also transmits, in order to accept the communication setting option in the Configure-Request frame from the communication apparatus Y, the Configure-Ack frame to the communication apparatus Y (step S706).

As described above, the communication apparatuses X and Y establish the LCP link by receiving the Configure-Ack frame from the opposite apparatus. In this case, the communication apparatus X preferably sets the flag monitoring function to the invalid condition. Therefore, the communication apparatus X does not implement the flag monitoring function. On the other hand, the communication apparatus Y preferably does not perform the flag monitoring operation because in this embodiment, it does not have the flag monitoring function.

In FIG. 7, when the communication apparatus Y has the flag monitoring function, and the recognize the communication option 301, it is also possible to form the structure to transmit. The LCP setting rejection frame for the “valid” setting depending on the predetermined condition may be transmitted to the other side. In this embodiment, the apparatus that receives the LCP setting rejection frame can re-transmit the LCP setting request frame without the communication option 301, or the LCP setting request frame including the communication option 301 where “valid” is set.

In one embodiment, the communication apparatus A of the present invention accommodates the Ethernet, which may follow the IEEE 802.3 protocol. The communication apparatus A terminates the Ethernet frame from the Ethernet, based on the MAC control portion 61, and transmits the Ethernet frame to the established PPP link after encapsulating the Ethernet frame to the POS frame.

When the opposite apparatus has detected disconnection of the PPP link with the structure of the POS control portion 50 and link control portion 60, the link control portion 60 of the opposite apparatus shifts to the link end phase 104 (FIG. 4) to implement the LCP link close sequence (FIG. 12) among the opposite apparatuses. Thereby, each communication apparatus enters the LCP link close condition.

However, the apparatus in the Ethernet frame transmitting side continuously transmits the Ethernet frame because it cannot recognize disconnection of the PPP link. The communication apparatus A of the present invention has the following structure, as described in more detail below.

Namely, the link control portion 60 of the communication apparatus A, as illustrated in FIG. 2, drives the flow control for the MAC control portion 61 mounted to the communication apparatus A based on the condition of PPP (LCP) link.

The link control portion 60 performs the control (1) to instruct the MAC control portion 61 to transmit the Pause frame, (intermission of transmission) specified in the IEEE 802.3x protocol. (control flow) This pause frame is transmitted to the Ethernet side in the timing of transition to the link OFF condition (namely, LCP link close condition (refer to 112 of FIG. 4)) and the control (2) to instruct the MAC control portion 61 to transmit the Pause frame (re-start of transmission) to the Ethernet side in the timing of transition to the link recovery condition (LCP link open condition (refer to 110 of FIG. 4)).

In some embodiment, the flow control specified in the IEEE 802.3x may have the following structure. The Ethernet frame received from the fully-duplicated Ethernet link may be stored in a buffer. The threshold value to drive the flow control and the threshold value for cancellation may be defined to the buffer. When the amount of the frame has exceeded the threshold value for a drive, a command called the Pause frame is transmitted to the Ethernet link to request intermission of the transmission. On the other hand, when the amount of a frame is under the threshold value for cancellation, the Pause frame indicating re-start of transmission is transmitted to the Ethernet link.

The condition where the amount of the frame has exceeded the threshold value for the drive is generated when the frame exceeding the bandwidth which allows transfer of signal is temporarily received from the Ethernet link. Moreover, such condition is also generated when the bandwidth of the SONET/SDH signal, for the purpose of mapping the Ethernet link is too narrow for the bandwidth of the Ethernet link. For example, the Ethernet link of 1 Gbps is mapped to STS-12c=622 Mbps.

The (opposite) apparatus on the Ethernet side, having received the Pause frame indicating intermission of transmission, has to stop the transmission of the Ethernet frame until the bit time designated with the intermission time field in the Pause frame passes. When the Pause frame indicating re-transmission (the Pause frame where the intermission time field is “0”) is received, transmission of the Ethernet frame is re-started.

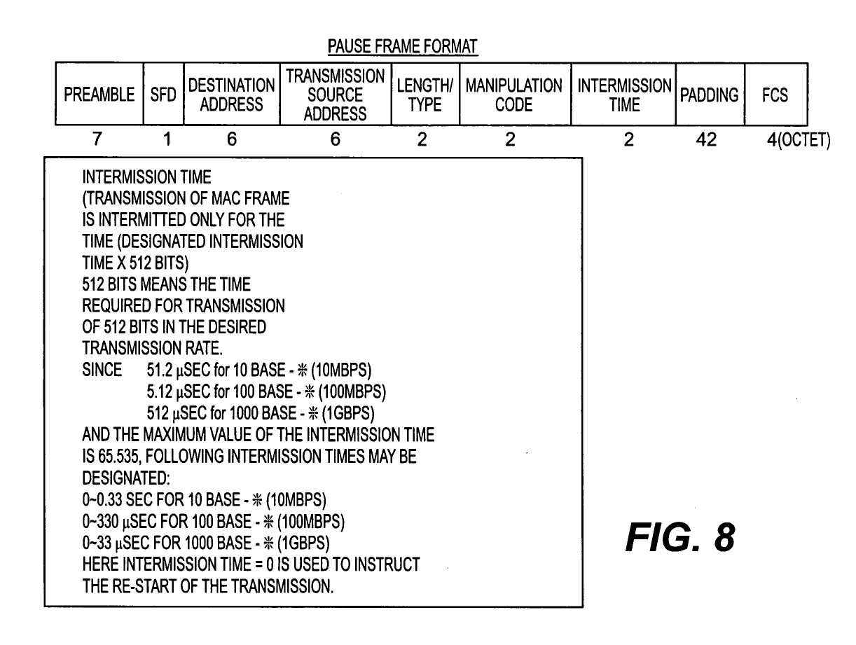

FIG. 8 illustrates an exemplary format of the Pause frame. The Pause frame preferably has the format of a MAC frame. In the FIG. 8 embodiment, a multicast address reserved for the Pause frame is set to the “Destination address”. As the “Transmission source address”, the MAC address on the transmitting side of the Pause frame is set but this designation may not be required.

In the “Length/Type” field and “Manipulation code” field, the fixed values (“0×8808”, “0×0001”) are designated respectively. In the “Intermission time” field, the designated values of 0 to 65,535 (variable) is set. Transmission of frame is suspended (intermitted) until the time of designated here×512 bits passes.

The “512 bits time” is different depending on the transfer rate. For example, when the Ethernet is 100 Mbps Ethernet, the “512 bits time” becomes about 5 μsec and the maximum intermission time becomes about 330 msec. If the condition where the link is disconnected continues to exceed the intermission time, the MAC control portion 61 periodically transmits (interval depends on the transfer rate) the Pause frame (intermission of transmission) and when the link OFF condition is recovered, the flow control is cancelled by transmitting a Pause frame with intermission time=0 (restart of transmission).

As described above, the present invention defines a change of link condition as the transmission trigger of the Pause frame. Thereby, while the link is disconnected for the opposite apparatus via the Ethernet (access link), the transmission of data (Ethernet frame) is queued and transmission is started again when the link is recovered. As described above, conformity of data transfer under the condition that the Ethernet frame is encapsulated to the POS frame may be guaranteed.

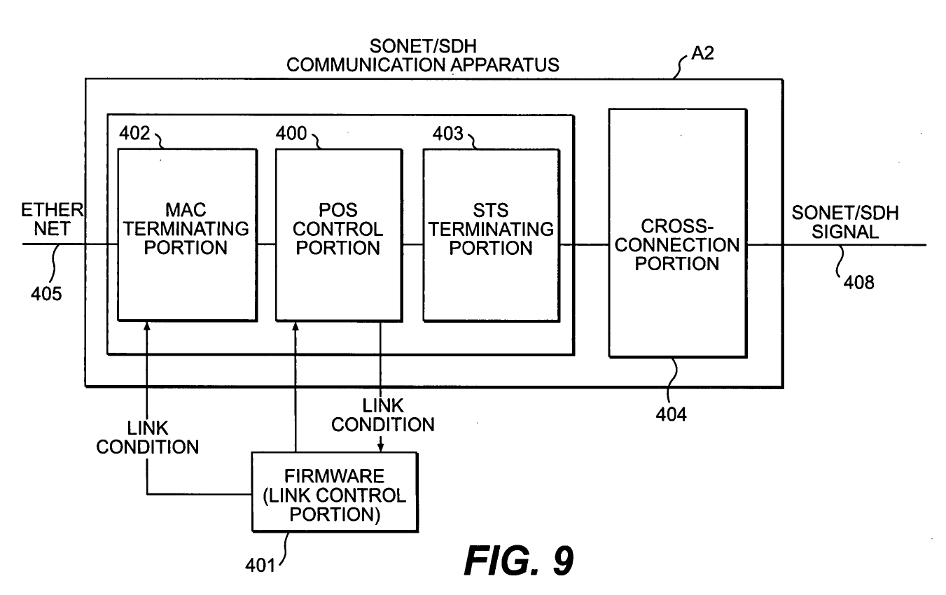

FIG. 9 illustrates an example of structure of the SONET/SDH communication apparatus to which the present invention is applied. In FIG. 9, a POS control portion 400, a firmware (link control portion) 401, a MAC terminating portion 402, an STS terminating portion 403 and a cross-connecting portion 404 are provided.

The MAC terminating portion 402 corresponds to the MAC control portion 61 of FIG. 2 to terminate the MAC frame (Ethernet frame) from the Ethernet link 405 and then transfers it to the POS control portion 400. Moreover, the MAC frame from the POS control portion 400 is transmitted to the Ethernet link 405. Moreover, the MAC terminating portion 402 executes the transmission process of the Pause frame for the apparatus in the MAC frame transmitting side connected via the Ethernet link 405 conforming to the instruction from the firmware (link control portion) 401.

The POS control portion 400 corresponds to the POS control portion 50 of FIG. 2. The POS control portion 400 transfers the MAC frame from the MAC terminating portion 402 to the STS terminating portion 403 by encapsulating it to the POS frame. Moreover, the POS control portion 400 extracts the MAC frame from the POS frame from the STS terminating portion 403 and then transfers it to the MAC terminating portion 402. In addition, the POS control portion 400 executes the link OFF determination processing procedure illustrated in FIG. 3 and indicates the link condition (link OFF) to the firmware 401.

The firmware 401 performs the link control portion 50 of FIG. 2. Namely, the firmware 401 executes the transition of condition illustrated in FIG. 5 and performs negotiations illustrated in FIG. 6 and FIG. 7 for the opposite apparatus in the link establishment phase 101 in order to set the valid/invalid condition of the flag monitoring function. Moreover, when invalidity of the flag monitoring function is set, the LCP ECHO request/response frame is transmitted or received.

Moreover, the firmware 401 shifts to the link end phase when the link condition is indicated. In addition, the firmware 401 instructs the MAC terminating portion 402 to transmit the Pause frame indicating intermission of transmission in the timing (trigger) when the link end phase shifts to the LCP link close condition and also instructs the MAC terminating portion 402 to transmit the Pause frame indicating the re-transmission in the timing (trigger) when the phase shifts to the LCP link open condition (recovery of link OFF condition).

The STS terminating portion 403 maps the POS frame generated by the POS control portion 400 to the STS payload and then transfers this POS frame to the cross-connecting portion 404. Moreover, the STS terminating portion 403 extracts the POS frame from the STS payload from the cross-connecting portion 404 and then transfers it to the POS control portion 400.

The cross-connecting portion 404 implements the cross-connection in unit of STS, connects an optical signal including the STS payload to the desired position and transmits the signal as the SONET/SDH signal to the opposite apparatus.

According to the communication apparatus described as the embodiment, the flag monitoring process is performed in place of the conventional method (transmission/reception of the LCP ECHO request/response frame) as the link monitoring process of the data link layer, such as PPP over SONET/SDH. Accordingly, the load to be consumed by message exchange (transmission/reception of the LCP ECHO request/response frame) for the link condition monitoring may be reduced to zero. Moreover, a disconnecting condition of the link can be determined quickly in comparison with the conventional method. Thereby, the problems (1), (2), (3), (4) and (6) described above can be solved.

Moreover, according to the communication apparatus described as the embodiment, while the link is disconnected, loss of data can be prevented by requesting stop of transmission from the apparatus which transmits the Ethernet to cause transmission of the data (Ethernet frame), which cannot be transmitted from the relevant apparatus after recovery of link and is accumulated therein. Thereby, the problem of (5) described above can be solved to ensure conformity of user data and improve quality of service for providing Internet and Intranet access.

In addition, according to the communication apparatus described as the embodiment, mutual connection with the existing communication apparatus which is not provided with the link monitoring function can be ensured without the necessity of being set by the user.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A communications apparatus comprising:
a receiving unit operable to receive link status flags, the link status flags included in frames received over a data communication link in response to link status flags included in frames transmitted over the data communication link; and
a link status determination unit operable to determine whether a condition of the data communication link is normal based on whether the link status flags are received within a predetermined time.

2. The communication apparatus according to claim 1, wherein the link status determination unit is further operable to determine that the condition of the data communication link is invalid when the link status flags are not received within the predetermined time.

3. The communication apparatus according to claim 2, further comprising a link control unit operable to close the data communication link when the data communication link is determined to be invalid.

4. The communication apparatus according to claim 3, wherein the link control unit is further operable to open the data communication link when the recovery of the data communication link is determined to be possible.

5. The communication apparatus according to claim 4, further comprising a negotiation unit operable negotiate validity or invalidity of the data communication link with a link status determination unit of another device connected to the data communication link.

6. The communication apparatus according to claim 5, wherein the negotiation unit is further operable to transmit information requesting validity or invalidity of the data communication link to the link status determination unit of the other device connected to the data communication link and to receive a response from the link status determination unit of the other device connected to the data communication link.

7. The communication apparatus according to claim 6, further comprising a setting unit operable to set the link status determination unit to a valid or invalid condition.

8. The communication apparatus according to claim 7, wherein the negotiation unit is further operable to transmit information indicating a valid condition of the link status determination unit to the other device connected to the data communication link and the setting unit is further operable to set the link status determination unit to an invalid condition when the negotiation unit receives response indicating invalidity of the link status determination unit of the other device connected to the data communication link.

9. The communication apparatus according to claim 7, further comprising a link monitoring unit which is operable when the link status determination unit is set to an invalid condition and is operable to transmit an inspection frame to inspect a condition of the data communication link to the other device connected to the data communication line and to determine that a condition of the data communication link is normal upon receiving a response frame for the inspection frame from the other device connected to the data communication line within the predetermined time.

10. The communication apparatus according to claim 4, further comprising:
a transmitter operable to transmit transmission object data received from a data transmission source over the data communication link; and
a data transmission control unit operable to suspend data transmission to the data transmission source when the data communication link is closed.

11. The communication apparatus according to claim 10, wherein the data transmission control unit is further operable to re-start data transmission to the data transmission source when the data communication link is re-opened.

12. The communication apparatus according to claim 4, further comprising:
a transmitter operable to transmit transmission object data received from a data transmission source over a data link layer of the data communication link; and
a data transmission control unit operable to suspend data transmission to the data transmission source when the data communication link is closed.

13. The communication apparatus according to claim 12, wherein the data transmission control unit is further operable to re-start data transmission to the data transmission source when the data communication link is re-opened.

14. A data link monitoring control method for communication apparatus comprising the steps of:
receiving unit link status flags, the link status flags included in frames received over a data communication link in response to link status flags included in frames transmitted over the data communication link; and
determining whether a condition of the data communication link is normal based on whether the link status flags are received within a predetermined time.

15. The method according to claim 14, further comprising the step of:
determining that the condition of the data communication link is invalid when the link status flags are not received within the predetermined time.

16. The method according to claim 15, further comprising the step of:
closing the data communication link when the data communication link is determined to be invalid.

17. The method according to claim 16, further comprising the step of:
opening the data communication link when the recovery of the data communication link is determined to be possible.

18. The method according to claim 17, further comprising the step of:
negotiating validity or invalidity of the data communication link another device connected to the data communication link.

19. The method according to claim 18, further comprising the steps of:
transmitting information requesting validity or invalidity of the data communication link to the other device connected to the data communication link; and
receiving a response from the other device connected to the data communication link.

20. The method according to claim 19, further comprising the step of:
setting the link status determination unit to a valid or invalid condition.

21. The method according to claim 20, further comprising the steps of:
transmitting information indicating a valid condition to the other device connected to the data communication link; and
setting an invalid condition indicating invalidity of the other device connected to the data communication link.

22. The method according to claim 20, further comprising the step of:
transmitting an inspection frame to inspect a condition of the data communication link to the other device connected to the data communication link; and
determining that a condition of the data communication link is normal upon receiving a response frame for the inspection frame from the other device connected to the data communication line within the predetermined time.

23. The method according to claim 17, further comprising the steps of:
transmitting transmission object data received from a data transmission source over the data communication link; and
suspending data transmission to the data transmission source when the data communication link is closed.

24. The method according to claim 23, further comprising the step of:
re-starting data transmission to the data transmission source when the data communication link is re-opened.

25. The method according to claim 17, further comprising the step of:
transmitting transmission object data received from a data transmission source over a data link layer of the data communication link; and
suspending data transmission to the data transmission source when the data communication link is closed.

26. The method according to claim 25, further comprising the step of:
re-starting data transmission to the data transmission source when the data communication link is re-opened.
